(19) United States
(12) Patent Application Publication
(10) Pub. No.: US 2009/0151263 A1
(43) Pub. Date: Jun. 18, 2009

(54) Device for operating a window

(76) Inventors: Claes Lindborg, Helsingborg (SE); Rune Ljung, Hoganas (SE)

Correspondence Address: BUCHANAN, INGERSOLL & ROONEY PC, POST OFFICE BOX 1404, ALEXANDRIA, VA, 22313-1404, US

(21) Appl. No.: 11/597,107

(22) PCT Filed: Apr. 21, 2005
(86) PCT No.: PCT/SE05/00575

§ 371 Date: Dec. 6, 2006

(30) Foreign Application Priority Data
May 21, 2004 (SE) 0401305-8

(51) Int. Cl. E05F 11/38

(52) U.S. Cl. 49/360

(57) ABSTRACT

A device for operating a vertical window, which is laterally displaceably mounted between an upper and a lower horizontal guide rail, has a handle, which is pivotally connected to a vertical frame part positioned at one lateral edge of the window, and a link element, which is hinged on a first and a second hinge axis and connected to the handle and, respectively, to a lower guide member which is positioned at said lateral edge of the window and arranged to engage the lower guide rail to guide the window on this. The handle and the link element are arranged to press, as the handle pivots from a starting position in one direction, said lower guide member downwards from an upper position so as to tilt the window to a tilted position. The device has an overcentre device, which comprises a spring, which biases said lower guide member and the link element hingedly connected thereto upwards in order to return, when the handle during said pivoting passes an overcentre pivot position beyond the pivot position in which the window has been tilted to its tilted position, the lower guide member to its upper position, in which, in the tilted position of the window, the lower guide member is disengaged from the lower guide rail.

### TECHNICAL FIELD

The present invention relates to an operating device for operating a vertical window, which is laterally displaceably mounted between an upper and a lower horizontal guide rail, the window having a rectangular frame, in the vicinity of each of its two upper frame corners having an upper guide means, which engages the upper guide rail, and in the vicinity of each of its two lower frame corners having a lower guide means, which engages the lower guide rail, the window in at least one displacement position along the guide rails being tiltable to a tilted position about an imaginary tilt axis positioned at one lateral edge of the window and extending perpendicular to the window.

### BACKGROUND ART

For glazing-in balconies, for instance, it is known to use sliding window arrangements which have an upper and a lower horizontal guide rail and a vertical window which is mounted between the guide rails and displaceable laterally along the same, said window having a rectangular frame with a pane mounted therein and in the vicinity of each of its two upper frame corners having an upper guide means, which engages the upper guide rail, and in the vicinity of each of its two lower frame corners having a lower guide means, which engages the lower guide rail, the window in a displacement end position being pivotable about a substantially vertical pivot shaft positioned at one lateral edge of the window, between a closed position, in which it extends along the guide rails, and an open position. In such glazing-in, a plurality of sliding window arrangements are arranged side by side along a balcony side. The upper guide rails of the sliding window arrangements are arranged side by side and formed on a common upper aluminium section, and their lower guide rails are correspondingly arranged side by side and formed on a common lower aluminium section. Each window is slidable back and forth along its two guide rails. The windows may take such a relative displacement position that they together cover the entire width of the balcony side, and they can also be displaced to an essentially common end position, in which the entire width of the balcony side less slightly more than the width of one window is open.

In a sliding window arrangement of this type according to PCT/SE2003/001527, a holding means is arranged on the upper guide rail and the lower guide rail has a stop means which is positioned so that the window, when on displacement in a direction towards said displacement end position it reaches this position, is stopped by the stop means and, owing to its kinetic energy, is tilted about an imaginary tilt axis extending perpendicular to the window to a tilted position, in which the lower guide means which is located at the lower, with regard to said direction rear, corner of the frame is disengaged from the lower guide rail and the upper guide means which is located at the upper, with regard to said direction front, corner of the frame engages the holding means on the upper guide rail in order to retain, in cooperation with the holding means, the window in the tilted position. The two guide means located at the upper and lower, with regard to said direction front, corners of the frame are arranged to form in said tilted position said substantially vertical pivot shaft. The window has an operating means, by means of which the upper guide means which is located at the upper, with regard to said direction rear, corner of the frame is disengageable from the upper guide rail in order to allow the window in said tilted position to be pivoted from the closed position to the open position.

This prior-art sliding window arrangement functions well, but it has been found that sometimes, due to excessive caution, the user displaces the window against the stop means with so little force that its kinetic energy is not sufficient to tilt the window.

### SUMMARY OF THE INVENTION

The object of the present invention therefore is to provide a simple operating device, by means of which the window can be operated and in particular tilted to a tilted position when it is in the displacement end position in a non-tilted state.

According to the invention, this object is achieved by an operating device, which is of the type defined by way of introduction and characterised in that it has a handle, which is pivotally connected to a vertical frame part positioned at the other lateral edge opposite to said one lateral edge of the window, and a link element, which is, hingedly on a first and a second hinge axis, connected to the handle and, respectively, to the lower guide means of the window positioned at said other lateral edge, the handle and the link element being arranged to press, as the handle pivots from a starting position in one direction, said lower guide means downwards from an upper position so as to tilt the window to said tilted position, and that the operating device further has an overcentre means, which comprises a spring, which biases said lower guide means and the link element hingedly connected thereto upwards in order to return, when the handle during said pivoting passes an overcentre pivot position beyond the pivot position in which the window has been tilted to its tilted position, the lower guide means to its upper position, in which, in the tilted position of the window, the lower guide means is disengaged from the lower guide rail.

The overcentre means comprises, in addition to the spring, preferably a guide pin defining said first hinge axis and a guide groove which is formed in the handle and in which the guide pin engages. The guide groove is suitably defined by a substantially plane upper guide surface, which is substantially horizontal when the handle is located in the overcentre pivot position.

The handle and the link element are preferably arranged to press, as the handle pivots towards and past the overcentre pivot position in the direction opposite to said one direction, the lower guide means downwards, the spring returning the lower guide means to its upper position as the handle passes the overcentre pivot position.

In a preferred embodiment, an operating rod is hingedly connected to the handle and to the upper guide means of the window positioned at said other lateral edge, the handle and the operating rod being arranged to move, as the handle pivots from said starting position in said one direction, said upper guide means downwards and thus disengage it from the upper guide rail and, as the handle pivots towards said starting position in the direction opposite to said one direction, move this upper guide means upwards into engagement with the upper guide rail.

### BRIEF DESCRIPTION OF THE DRAWINGS

The invention will now be described in more detail with reference to the accompanying drawings.

FIG. 1 is a front view and shows a sliding window arrangement, a window included in the arrangement being shown in a displacement position in the vicinity of a displacement end position.

FIG. 2 is a front view and shows the arrangement in FIG. 1 with the window in the displacement end position.

FIG. 3 is a front view and shows the arrangement in FIGS. 1 and 2 with the window in the displacement end position and in an overtilted state.

FIGS. 4-6 are front views and show the arrangement in FIGS. 1-3 with the window in the displacement end position and in a tilted state and with an operating device according to the present invention in different pivot positions.

FIG. 7 is a front view and shows the arrangement in FIGS. 1-6 with the window in the displacement end position and in the overtilted state shown in FIG. 3, but the operating device being in a pivot phase different from that in FIG. 3.

FIG. 8 is front view and shows the arrangement in FIGS. 1-7 with the window in the displacement end position and in the tilted state shown in FIGS. 4-6, but the operating device being in a pivot position different from that in FIGS. 4-6.

FIG. 9 is a front view and shows the arrangement in FIGS. 1-8 with a stop means included in the arrangement in a moved-away position and with the window in a position moved slightly beyond the displacement end position.

FIG. 10 shows the arrangement in the direction of the arrow X in FIG. 1.

FIG. 11 shows the arrangement in the direction of the arrow XI in FIG. 1 with a lower and an upper portion of the window broken away.

FIG. 12 shows the arrangement in the direction of the arrow XII in FIG. 3.

FIG. 13 shows the arrangement in the direction of the arrow XIII in FIG. 5.

FIG. 14 shows the portion encircled in FIG. 1 of the arrangement on a larger scale.

FIG. 15 shows the portion encircled in FIG. 4 of the arrangement on a larger scale.

FIG. 16 is a sectional view and shows one edge portion of the window, with a handle included in the operating device according to the present invention, which device is arranged in this edge portion, the handle being shown in a starting pivot position, corresponding to the position shown in FIGS. 1 and 2.

FIG. 17 is a sectional view corresponding to FIG. 16, and shows the handle in a partly upwards pivoted position, substantially corresponding to the position shown in FIG. 3.

FIG. 18 is a sectional view corresponding to FIGS. 16 and 17, and shows the handle in a fully upwards pivoted position.

### DESCRIPTION OF A PREFERRED EMBODIMENT

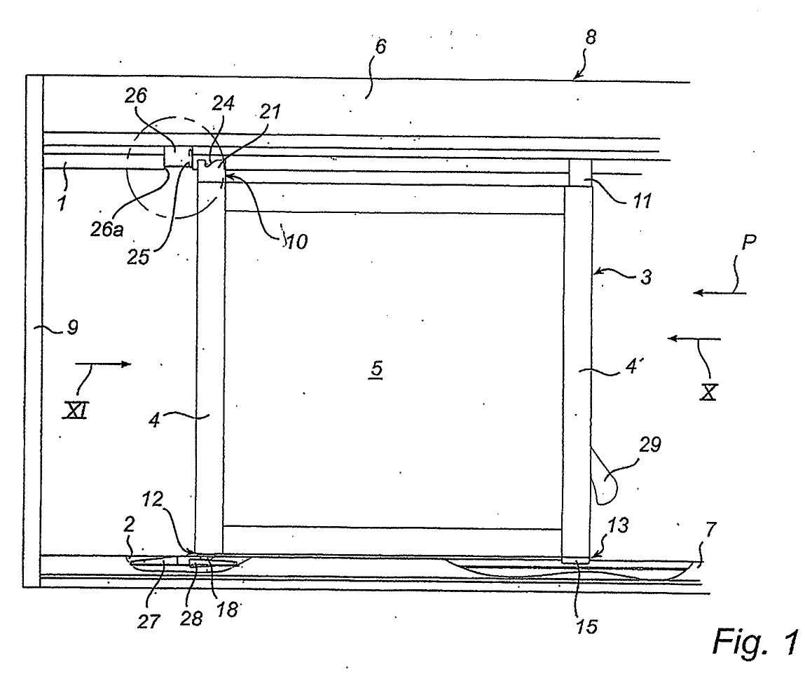

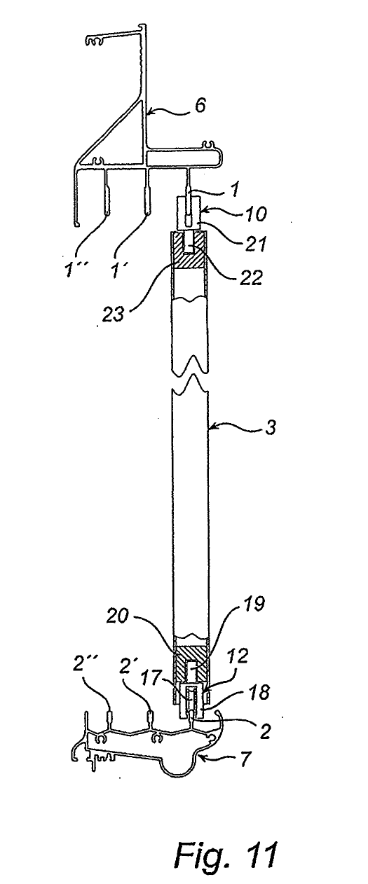

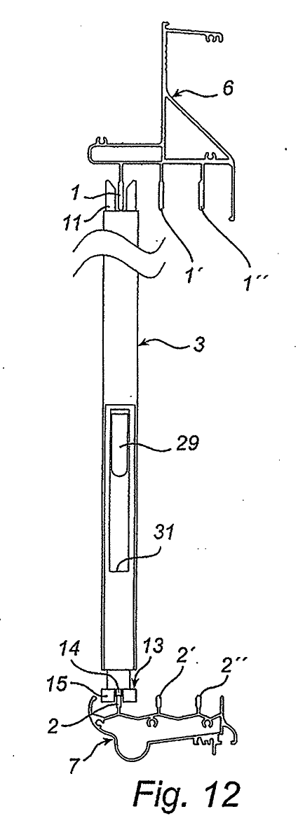

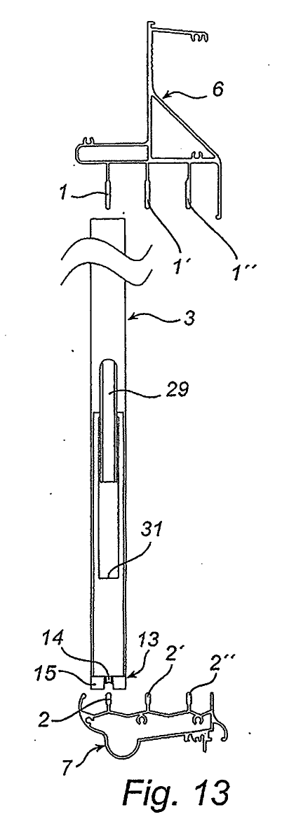

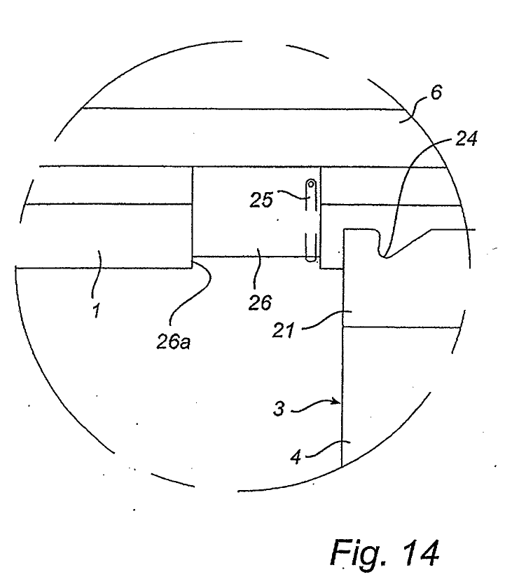

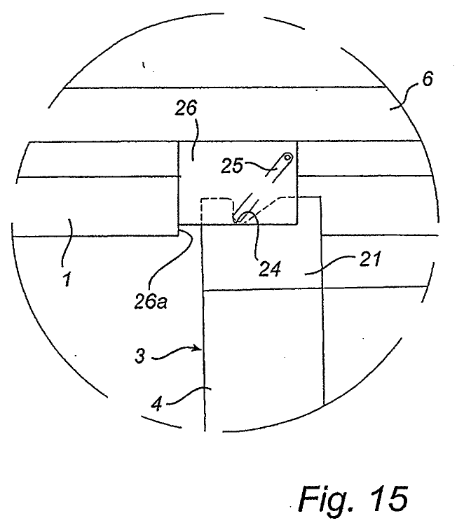

The sliding window arrangement shown in FIGS. 1-15 has an upper horizontal guide rail 1 and, parallel and straight below the same, a lower horizontal guide rail 2. The arrangement further has a vertically arranged window 3, which has a rectangular frame 4 and a glass pane 5 mounted therein. The window 3 is mounted between the guide rails 1, 2 and slidable along the same.

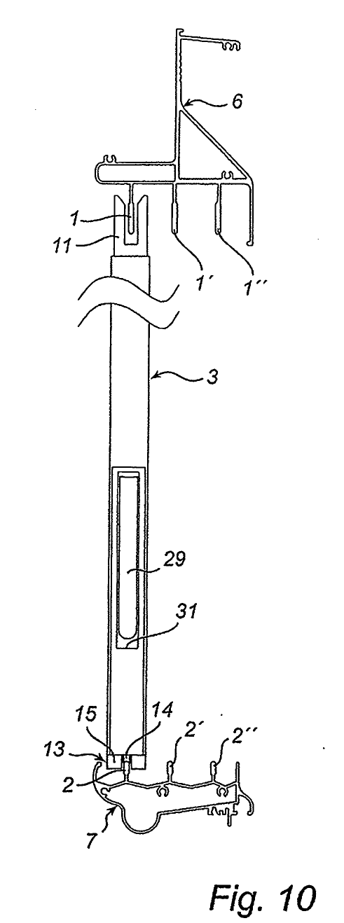

In the shown embodiment, the upper and the lower guide rail 1 and 2 constitute one of three guide rails 1, 1′, 1″ and 2, 2′, 2″, respectively, which are formed on an upper aluminium sectional element 6 and a lower aluminium sectional element 7, respectively (see FIGS. 10-13). The two sectional elements 6 and 7 constitute horizontal frame parts in a mounting frame 8, which also has two vertical frame parts, of which one 9 is shown in FIGS. 1-9. The mounting frame 8 is included in an arrangement for glazing-in a balcony and covers a balcony side. A window (not shown) which is identical with the window 3 is mounted between each pair of upper and lower guide rails 1′, 2′ and 1″, 2″ and is, like the window 3, slidable along its guide rails.

The frame 4 has in the vicinity of each of its two upper corners an upper guide means 10, 11 which engages the upper guide rail 1, and in the vicinity of each of its two lower corners a lower guide means 12, 13 which engages the lower guide rail 2. These guide means 10-13 hold the window 3 in place on the guide rails 1 and 2.

The lower guide means 13 located at the lower, with regard to one displacement direction P (to the left in FIGS. 1-9) of the window 3 rear, corner of the frame 4 comprises a wheel 14, which has a circumferential groove in its circumferential surface and is arranged to roll on the lower guide rail 2 when this is placed in the groove. This guide means 13 also comprises a fork-shaped part 15, which with its two legs from above straddles the upper portion of the lower guide rail 2. The wheel 14 is supported by and rotatably mounted between the legs of the fork-shaped part 15.

The upper guide means 11 located at the upper, with regard to the displacement direction P rear, corner of the frame 4 consists of a fork-shaped part, which with its two legs from below straddles the lower portion of the upper guide rail 1. The guide means 11 can, in a manner that will be described in more detail below, be disengaged from the upper guide rail 1.

The lower guide means 12 located at the lower, with regard to the displacement direction P front, corner of the frame 4 comprises a wheel 17, which has a circumferential groove in its circumferential surface and is arranged to roll on the lower guide rail 2 when this is placed in the groove. This guide means 12 also comprises a fork-shaped part 18, which with its two legs from above straddles the upper portion of the lower guide rail 2. The wheel 17 is supported by and rotatably mounted between the legs of the fork-shaped part 18. The fork-shaped part 18 has an upwards extending vertical pivot pin 19, which is pivotally mounted in a block 20, which is attached inside the vertical, with regard to the displacement direction P front, frame part of the frame 4.

As is evident, the window is supported on the lower guide rail 2 by the two wheels 14 and 17.

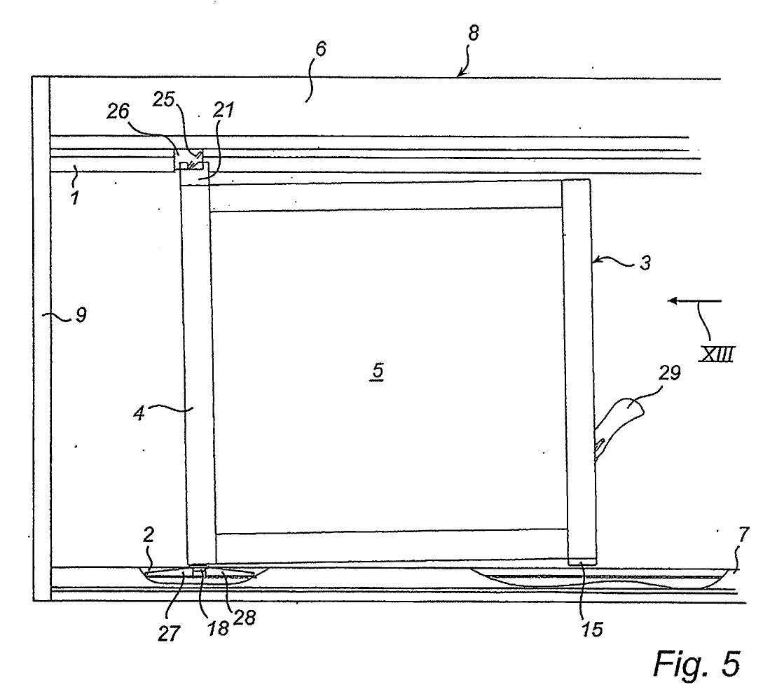

The upper guide means 10 located at the upper, with regard to the displacement direction P front, corner of the frame 4 comprises a fork-shaped part 21, which with its two legs from below straddles the lower portion of the upper guide rail 1 (see FIG. 10). The fork-shaped part 21 has a downwards extending vertical pivot pin 22, which is pivotally mounted in a block 23, which is attached inside the vertical, with regard to the displacement direction P front, frame part of the frame 4. The pivot pin 22 is positioned in axial alignment with the pivot pin 19 so as to form, together with this, a pivot shaft, about which the window 3 is pivotable when it is located in a displacement end position and takes a tilted state (see FIG. 5).

The fork-shaped part 21 has at its upper side a horizontal groove 24 which is substantially V-shaped in cross-section and extends perpendicular to the upper guide rail 1 and whose, with regard to the displacement direction P front, groove wall forms a stop lug and whose, with regard to the displacement direction P rear, groove wall is inclined obliquely downwards forwards.

A holding means has the form of a pawl 25 which is mounted in a mounting part 26 and freely pivotable about a pivot shaft extending parallel to the groove 24, said mounting part in turn being attached to the upper sectional element 6 straight in front of a recess 26a which is formed therein and extends a distance up from the underside of the upper guide rail 1. The mounting part 26 has in cross-section, perpendicular to the upper guide rail 1, the shape of an inverted U, between the legs of which the pawl 25 is placed. The distance between these legs is equal to the width of the fork-shaped part 21, the fork-shaped part 21 being guided by these legs in the portion of the upper guide rail 1 where the recess 26a is located, i.e. where it cannot be guided by the upper guide rail 1.

A stop means 27 is attached to the lower guide rail 2 in the vicinity of the vertical frame part 9 of the mounting frame 8. The stop means 27 is placed in such a manner that the window 3, when on displacement in the direction P it reaches a displacement end position, bumps against the stop means 27 in its lower, with regard to the displacement direction P front, frame corner and, owing to its kinetic energy, is tilted about an imaginary tilt axis extending perpendicular to the window to a tilted position.

The stop means 27 has a height decreasing in a wedge-shaped manner in the displacement direction P and is, at its narrow, with regard to the displacement direction P front, end mounted on the lower guide rail 2 to be pivotable about a pivot shaft which is perpendicular to the lower guide rail 2. The stop means 27 is, against the action of a spring (not shown), pivotable from an upper operative position, in which it is normally held to serve as a stop means, to a lower inoperative position, in which it allows displacement of the window 3 from the displacement end position in the displacement direction P. When the stop means 27 is in its upper position, its upper side forms a ramp surface sloping downwards in the displacement direction P.

A locking means 28 has a height decreasing in a wedge-shaped manner in the direction opposite to the displacement direction P and is at its narrow, with regard to the displacement direction P rear, end mounted on the lower guide rail 2 to be pivotable about a pivot shaft which is perpendicular to the lower guide rail 2. The locking means 28 is, against the action of a spring (not shown), pivotable from an upper operative position, in which it is normally held to serve as a locking means, to a lower inoperative position, in which it allows displacement of the window 3 from the displacement end position in the direction opposite to the displacement direction P. When the locking means 28 is in its upper position, its upper side forms a ramp surface sloping upwards in the displacement direction P.

The stop means 27 and the locking means 28 have such a distance to each other that they form a gap between them which has the same extent in the longitudinal direction of the lower guide rail 2 as the fork-shaped part 18 of the lower, with regard to the displacement direction P front, guide means 12.

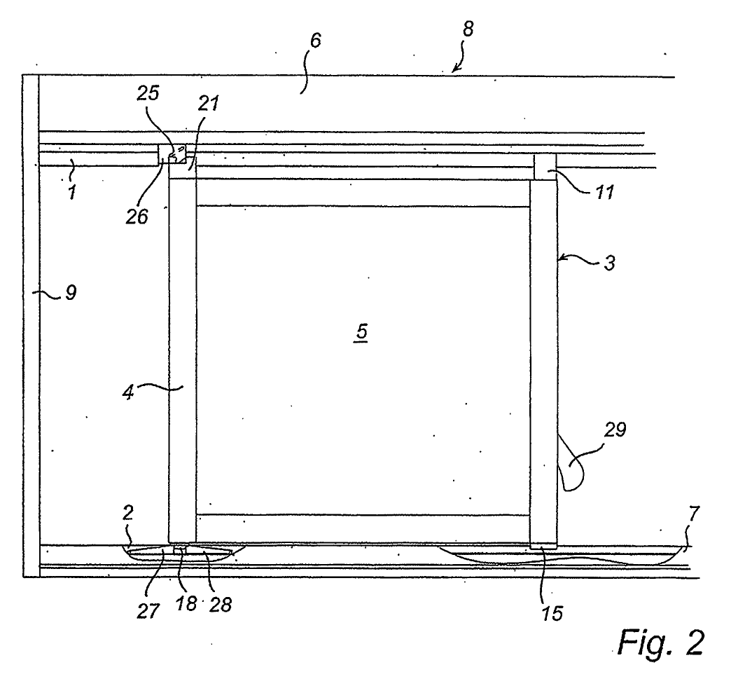

When the window 3 is displaced from a position to the right of the position shown in FIG. 1 in the displacement direction P, the fork-shaped part 18 of the guide means 12 bumps in its lower portion against the ramp surface formed of the locking means 28 (FIG. 1) and presses, in the continued displacement of the window 3, the locking means down to its lower position. When the window 3 reaches the displacement end position (FIG. 2), the fork-shaped part 18 bumps against the stop means 27 and the locking means 28 is returned by spring action to its upper position, so that the fork-shaped part 18 is locked between the stop means 27 and the locking means 28.

During the described displacement, also the fork-shaped part 21 of the upper guide means 10 comes into abutment against the vertically suspended pawl 25 and pivots this a distance clockwise (FIG. 2).

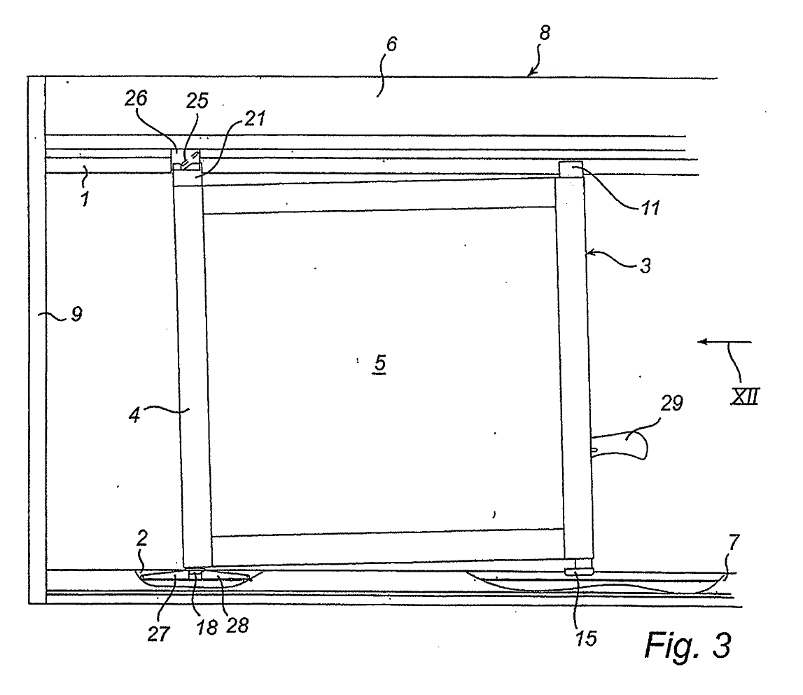

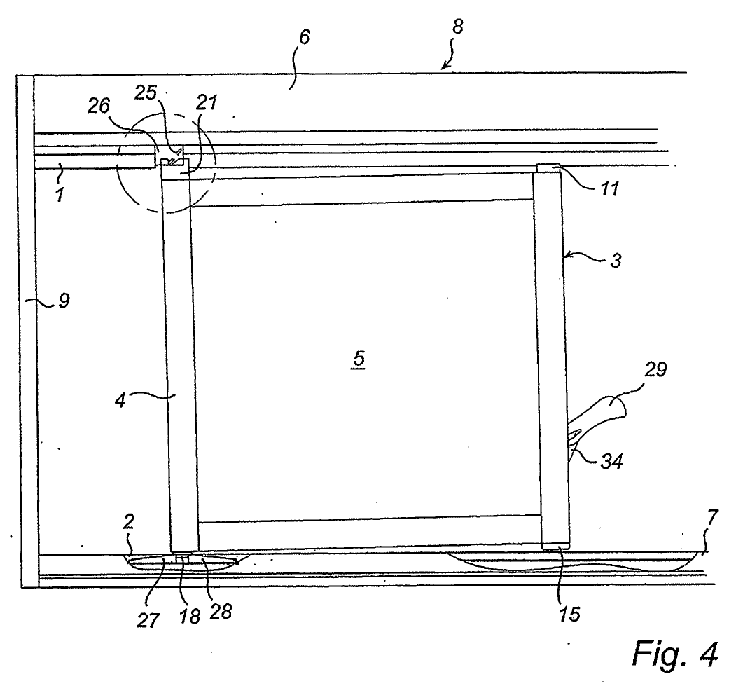

When the fork-shaped part 18 bumps against the stop means 27, the window 3 is tilted, owing to its kinetic energy, about an imaginary tilt axis extending perpendicular to the window beyond a tilted position (FIGS. 4-6) to an overtilted position (FIG. 3), in which the free end of the pawl 25 pivoted by the fork-shaped part 21 in the clockwise direction passes the upper edge of the wall, with regard to the displacement direction P front wall, of the groove 24, the pawl 25 by its own weight falling down in the groove 24 while pivoting in the counterclockwise direction. The window 3 falls by its own weight back to the tilted position (FIGS. 4-6). When the window 3 is in the tilted position, the pawl 25 engages in the groove 24 while abutting against the bottom of the groove and the stop lug formed by the front groove wall. The pawl 25 thus retains the window 3 in the tilted position, in which besides the guide means 13 is raised and disengaged from the lower guide rail 2 (FIG. 4). If, when the window 3 is in the tilted position, the upper guide means 11 is disengaged from the upper guide rail 1 (FIG. 5), the window 3 can be pivoted about the pivot shaft formed by the two pivot pins 19 and 22 to the desired opening position.

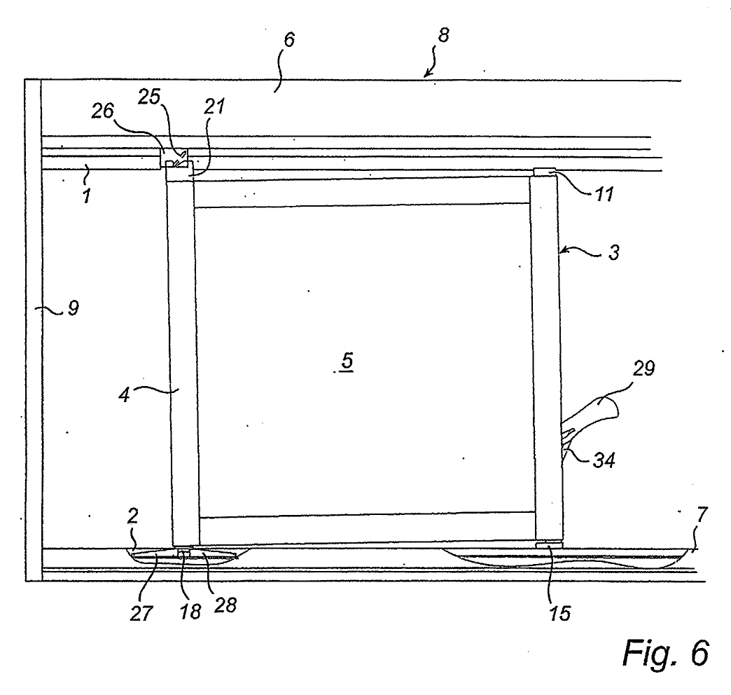

After pivoting the window 3 back and closing it, the upper guide means 11 is raised into engagement with the upper guide rail 1 (FIGS. 6-8).

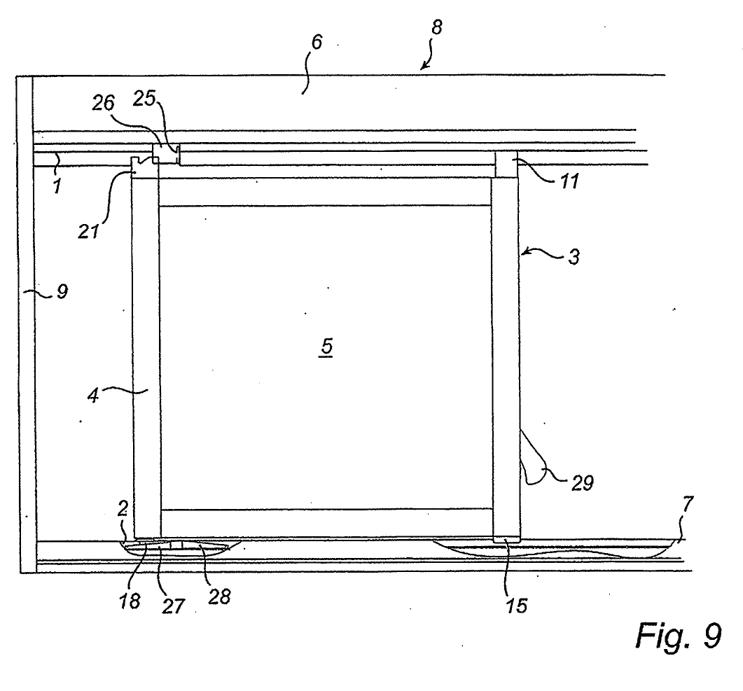

When the window 3 has been closed in this manner, the stop means 27 is to be pressed down to its lower position, so that the fork-shaped part 18 is released. After that, the window 3 tilts by its own weight back to a non-tilted position, and the guide means 13 is once more moved into engagement with the lower guide rail 2. The fork-shaped part 18 will in this tilting-back be placed over the stop means 27 and thus keeps this in the lower position. The window 3 can now be further displaced in the displacement direction P in order to release the pawl 25. In this further displacement, the pawl 25 is pivoted clockwise and finally reaches such a position relative to the fork-shaped part 21 that it falls by its own weight to the vertical position by pivoting in the counterclockwise direction (FIG. 9). The window can now, without being locked by the pawl 25 and the locking means 28, if this has been pressed down to its lower position, be displaced to an arbitrary position in the direction opposite to the displacement direction P.

If the window 3 is moved forwards to the stop means 27 in the displacement direction P with so little kinetic energy as not to be tilted, or for some other reason is in a non-tilted state with the fork-shaped part 18 of the guide means 12 locked between the stop means 27 and the locking means 28, it is convenient to use the operating device according to the present invention for operating the window 3.

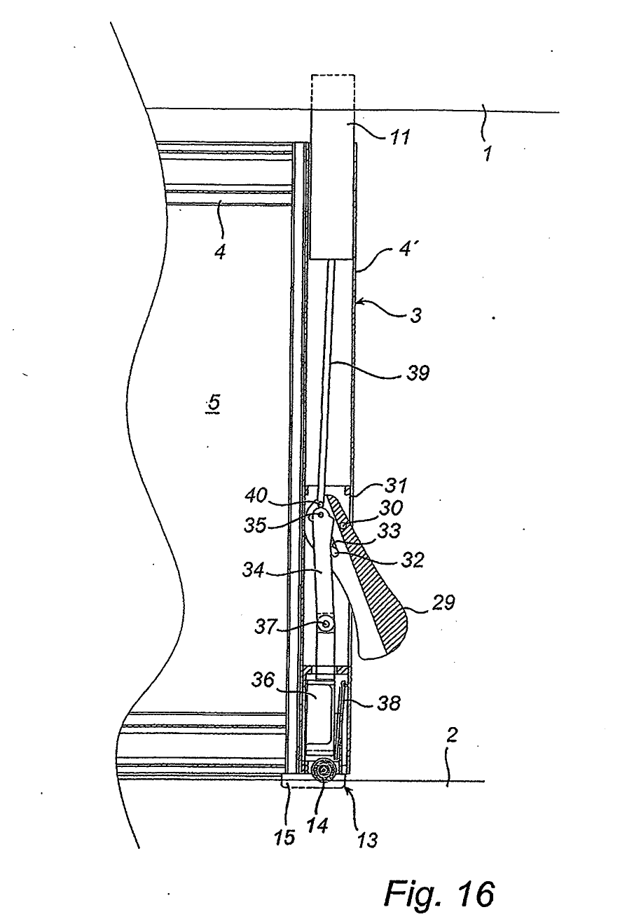

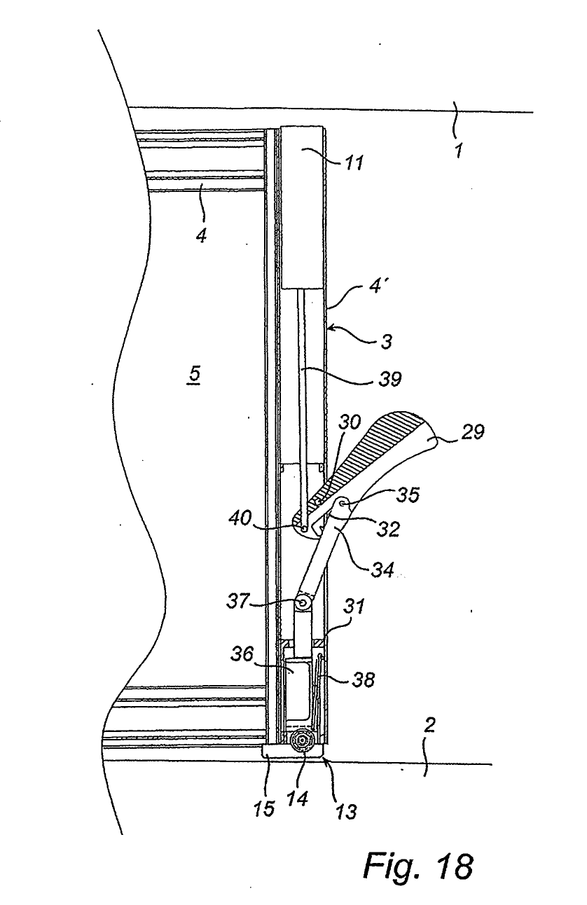

The operating device is, as is evident from FIGS. 16-18, arranged in the vertical, with regard to the displacement direction P rear, frame part 4′ of the frame 4. The operating device has a handle 29, which is pivotally connected to the frame part 4′ about a pivot pin 30 extending perpendicular to the window 3 and which via an opening 31 in the frame part 4′ projects from the rear edge surface of the frame 4. The handle 29 has a guide groove 32 which extends in the longitudinal direction of the handle and which is defined by a substantially plane upper guide surface 33. The handle 29 is pivotable between the starting pivot position shown in FIG. 16, in which it is inclined obliquely downwards at an angle of about 20° in relation to the frame part 4′, and the fully upwards pivoted position shown in FIG. 18, in which it is inclined obliquely upwards at an angle of about 45° in relation to the frame part 4′.

The operating device also has a link element 34, which is hingedly connected to the handle 29 by means of a guide pin 35 which extends parallel to the pivot pin 30 and which engages in the guide groove 32 while abutting against the guide surface 33. The link element 34 is also hingedly connected to a connecting part 36, which is rigidly connected to the guide means 13, by means of a hinge pin 37 extending parallel to the pivot pin 30 and the guide pin 35. A substantially vertical tension spring 38 is at its upper end attached to the frame part 4′ and at its lower end attached to the guide means 13 in order to bias this and, thus, the connecting part 36 and the link element 34 upwards. As a result, the guide pin 35 is pressed into abutment against the guide surface 33 and, in the starting pivot position of the handle 29 shown in FIG. 16, also into abutment against one end wall, in this position the upper end wall, of the guide groove 32.

The spring 38, the link element 34 with the guide pin 35 and the guide groove 32 with the guide surface 33 form an overcentre means whose function will be described in more detail below.

Finally the operating device also has a substantially vertical operating rod 39, which at its lower end is hingedly connected to the handle 29 by means of a hinge pin 40 extending parallel to the pins 30, 35, 37 and which at its upper end is hingedly connected to the guide means 11 by means of a hinge pin (not shown) extending parallel to the pins 30, 35, 37 and 40.

The function of the operating device will now be described in more detail based on the position shown in FIG. 2, in which the window 3 is in the displacement end position, i.e. the fork-shaped part 18 of the guide means 12 is locked between the stop means 27 and the locking means 28, and the handle 29 is in its starting pivot position (FIG. 16).

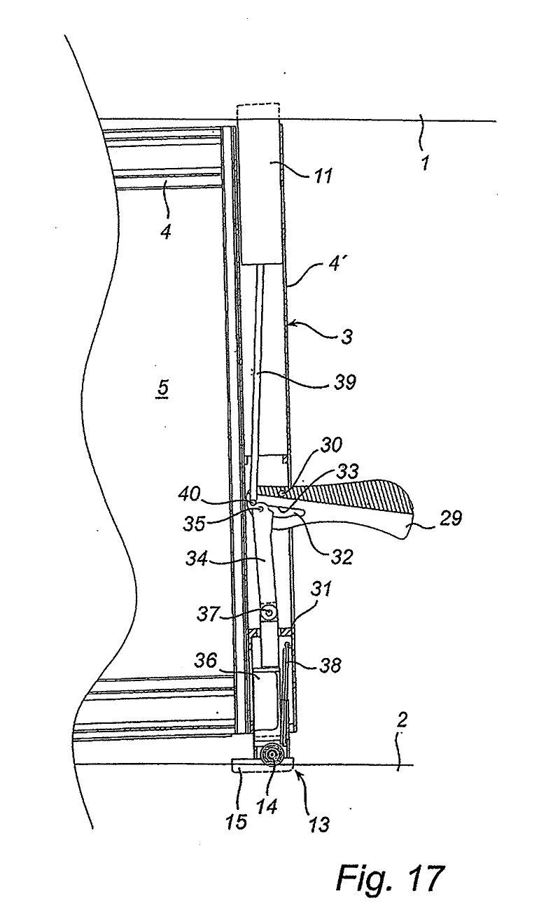

When the handle 29 is pivoted upwards in the direction P1, i.e. counterclockwise in FIG. 16, the link element 34 and thus both the connecting part 36 and the guide means 13 are pressed downwards against the action of the spring 38 (FIG. 17), which, owing to the wheel 14 resting against the lower guide rail 2, causes the window 3 to be tilted about said imaginary axis to the overtilted position shown in FIG. 3, in which the pawl 25 falls down in the groove 24 in the fork-shaped part 21 of the guide means 10. In this pivoting of the handle 29, the operating rod 39 and, thus, the upper guide means 11 are moved downwards, as shown in FIGS. 3, 4 and 17.

When the handle 29, while pivoting in the direction of the arrow P1, has passed its pivot position corresponding to the overtilted position of the window 3, and passes an overcentre pivot position, in which the guide surface 33 is substantially horizontal, the guide means 13 is returned to its upper position by the spring 38 quickly pressing the guide pin 35 of the bistable link element 34 to the other end wall of the guide groove 32, which in the continued pivoting of the handle 29 in the direction P1 now constitutes the upper end wall of the guide groove. When the guide means 13 is in its upper position and its wheel 14 thus does not rest against the lower guide rail 2 any longer, the window 3 tilts by its own weight back to the tilted position (see FIG. 4).

In continued pivoting of the handle 29 in the direction of the arrow P1 to the fully upwards pivoted position shown in FIGS. 5 and 18, the upper guide means 11 is fully inserted into the vertical frame part 4′ to be disengaged from the upper guide rail 1. The window 3 can then be pivoted to an open position.

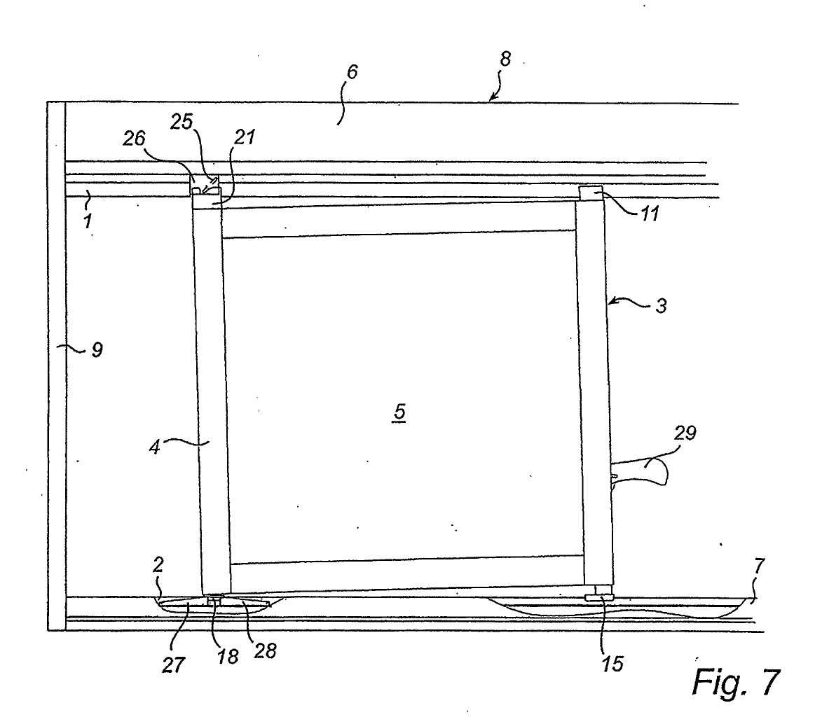

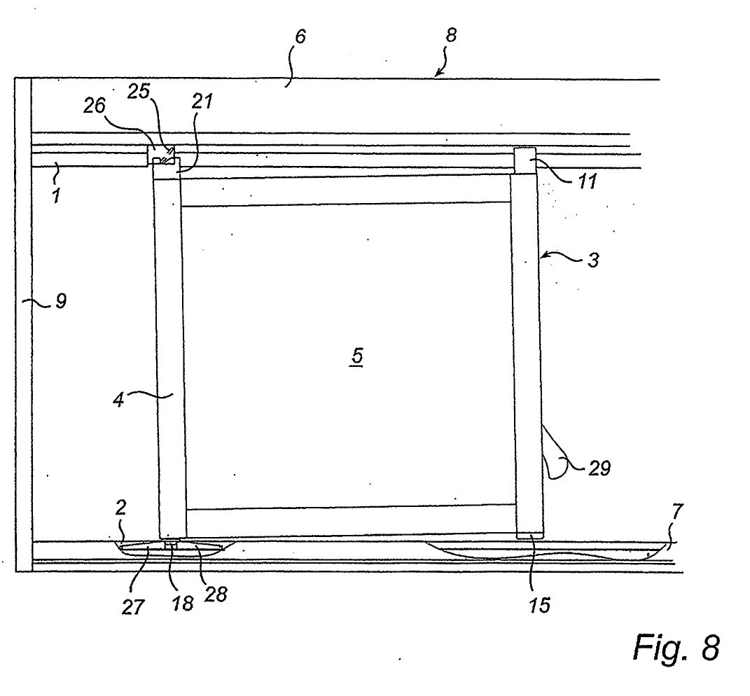

When the window 3 has been closed again, the handle 29 is pivoted in the direction opposite to the arrow P1, i.e. clockwise in FIG. 18, whereby the operating rod 39 is moved upwards and the upper guide means 11 is engaged with the upper guide rail 1, while at the same time the link element 34 and thus both the connecting part 36 and the guide means 13 are pressed down against the action of the spring 38 (see FIGS. 6 and 7). When the handle 29 passes its overcentre pivot position, the guide means 13 is returned to its upper position (see FIG. 8) by the spring 38 quickly pressing the guide pin 35 of the bistable link element 34 to the opposite end wall of the guide groove 32. In continued pivoting of the handle 29 to the starting pivot position in the direction opposite to the arrow P1, the upper guide means 11 is moved further upwards to such a projecting position that, when the window 3 has tilted back to a non-tilted position (FIG. 9), it still engages the upper guide rail 1.

1. An operating device for operating a vertical window (3), which is laterally displaceably mounted between an upper and a lower horizontal guide rail (1, 2), the window (3) having a rectangular frame (4), in the vicinity of each of its two upper frame corners having an upper guide means (10, 11), which engages the upper guide rail (1), and in the vicinity of each of its two lower frame corners having a lower guide means (12, 13), which engages the lower guide rail (2), the window (3) in at least one displacement position along the guide rails (1, 2) being tiltable to a tilted position about an imaginary tilt axis positioned at one lateral edge of the window (3) and extending perpendicular to the window,
wherein
the operating device has a handle (29), which is pivotally connected to a vertical frame part (4′) positioned at the other lateral edge opposite to said one lateral edge of the window (3), and a link element (34), which is, hingedly on a first and a second hinge axis (35 and 37 respectively), connected to the handle (29) and, respectively, to the lower guide means (13) of the window (3) positioned at said other lateral edge, the handle (29) and the link element (34) being arranged to press, as the handle pivots from a starting position in one direction (P1), said lower guide means (13) downwards from an upper position so as to tilt the window (3) to said tilted position, and that the operating device further has an overcentre means (32, 33, 34, 35, 38), which comprises a spring (38), which biases said lower guide means (13) and the link element (34) hingedly connected thereto upwards in order to return, when the handle (29) during said pivoting passes an overcentre pivot position beyond the pivot position in which the window (3) has been tilted to its tilted position, the lower guide means (13) to its upper position, in which, in the tilted position of the window, the lower guide means is disengaged from the lower guide rail (2).

2. An operating device as claimed in claim 1, in which the overcentre means (32, 33, 34, 35, 38) comprises, in addition to the spring (38), a guide pin (35) defining said first hinge axis and a guide groove (32) which is formed in the handle (29) and in which the guide pin engages.

3. An operating device as claimed in claim 2, in which the guide groove (32) is defined by a substantially plane upper guide surface (33), which is substantially horizontal when the handle (29) is located in the overcentre pivot position.

4. An operating device as claimed in claim 1, in which the handle (29) and the link element (34) are arranged to press, as the handle pivots towards and past the overcentre pivot position in the direction opposite to said one direction (P1), the lower guide means (13) downwards, the spring (38) returning the lower guide means (13) to its upper position as the handle (29) passes the overcentre pivot position.

5. An operating device as claimed in claim 1, in which an operating rod (39) is hingedly connected to the handle (29) and to the upper guide means (11) of the window (3) positioned at said other lateral edge, the handle (29) and the operating rod (39) being arranged to move, as the handle pivots from said starting position in said one direction (P1), said upper guide means (11) downwards and thus disengage it from the upper guide rail (1) and, as the handle pivots towards said starting position in the direction opposite to said one direction (P1), move this upper guide means (11) upwards into engagement with the upper guide rail (1).

6. An operating device as claimed in claim 2, in which the handle (29) and the link element (34) are arranged to press, as the handle pivots towards and past the overcentre pivot position in the direction opposite to said one direction (P1), the lower guide means (13) downwards, the spring (38) returning the lower guide means (13) to its upper position as the handle (29) passes the overcentre pivot position.

7. An operating device as claimed in claim 3, in which the handle (29) and the link element (34) are arranged to press, as the handle pivots towards and past the overcentre pivot position in the direction opposite to said one direction (P1), the lower guide means (13) downwards, the spring (38) returning the lower guide means (13) to its upper position as the handle (29) passes the overcentre pivot position.

8. An operating device as claimed in claim 2, in which an operating rod (39) is hingedly connected to the handle (29) and to the upper guide means (11) of the window (3) positioned at said other lateral edge, the handle (29) and the operating rod (39) being arranged to move, as the handle pivots from said starting position in said one direction (P1), said upper guide means (11) downwards and thus disengage it from the upper guide rail (1) and, as the handle pivots towards said starting position in the direction opposite to said one direction (P1), move this upper guide means (11) upwards into engagement with the upper guide rail (1).

9. An operating device as claimed in claim 3, in which an operating rod (39) is hingedly connected to the handle (29) and to the upper guide means (11) of the window (3) positioned at said other lateral edge, the handle (29) and the operating rod (39) being arranged to move, as the handle pivots from said starting position in said one direction (P1), said upper guide means (11) downwards and thus disengage it from the upper guide rail (1) and, as the handle pivots towards said starting position in the direction opposite to said one direction (P1), move this upper guide means (11) upwards into engagement with the upper guide rail (1).

10. An operating device as claimed in claim 4, in which an operating rod (39) is hingedly connected to the handle (29) and to the upper guide means (11) of the window (3) positioned at said other lateral edge, the handle (29) and the operating rod (39) being arranged to move, as the handle pivots from said starting position in said one direction (P1), said upper guide means (11) downwards and thus disengage it from the upper guide rail (1) and, as the handle pivots towards said starting position in the direction opposite to said one direction (P1), move this upper guide means (11) upwards into engagement with the upper guide rail (1).

11. An operating device as claimed in claim 6, in which an operating rod (39) is hingedly connected to the handle (29) and to the upper guide means (11) of the window (3) positioned at said other lateral edge, the handle (29) and the operating rod (39) being arranged to move, as the handle pivots from said starting position in said one direction (P1), said upper guide means (11) downwards and thus disengage it from the upper guide rail (1) and, as the handle pivots towards said starting position in the direction opposite to said one direction (P1), move this upper guide means (11) upwards into engagement with the upper guide rail (1).

12. An operating device as claimed in claim 7, in which an operating rod (39) is hingedly connected to the handle (29) and to the upper guide means (11) of the window (3) positioned at said other lateral edge, the handle (29) and the operating rod (39) being arranged to move, as the handle pivots from said starting position in said one direction (P1), said upper guide means (11) downwards and thus disengage it from the upper guide rail (1) and, as the handle pivots towards said starting position in the direction opposite to said one direction (P1), move this upper guide means (11) upwards into engagement with the upper guide rail (1).
